(19) United States
(12) Patent Application Publication
(10) Pub. No.: US 2025/0037886 A1
(43) Pub. Date: Jan. 30, 2025

(54) NUCLEAR REACTOR PROVIDED WITH A PROTECTION SYSTEM CHARACTERIZED BY MULTIPLE ACTUATION PHENOMENA

(71) Applicant: NEWCLEO LTD, London (GB)

(72) Inventor: Luciano Cinotti, Torino (IT)

(21) Appl. No.: 18/714,160

(22) PCT Filed: Dec. 2, 2022
(86) PCT No.: PCT/IB2022/061692

§ 371 Date: May 29, 2024

(30) Foreign Application Priority Data
Dec. 6, 2021 (IT) 102021000030758

(51) Int. Cl. G21C 9/033; G21C 9/02; G21C 11/06

(52) U.S. Cl. CPC G21C 9/033; G21C 9/022; G21C 11/06

(57) ABSTRACT

A fast nuclear reactor, provided with a protection system for shutdown of the reactor in accidental conditions and comprising shutdown devices that surround the core of the reactor and have an upper volume and a lower volume separated by a septum. The upper volume contains an operating fluid partly facing the active part of the core with neutron reflecting function to facilitate reaching the critical mass of the reactor. The lower volume contains a neutron transparent medium (for example gas) or a neutron absorbing medium (for example boron carbide balls immersed in the primary coolant). Replacement in the volume of the neutron reflecting medium with a neutron transparent or absorbing medium reduces the reactivity of the reactor and causes its shutdown.

### CROSS-REFERENCE TO RELATED APPLICATIONS

This patent application claims priority from Italian patent application no. 102021000030758 filed on Dec. 6, 2021, the entire disclosure of which is incorporated herein by reference.

### TECHNICAL FIELD

The present invention relates to a nuclear reactor, in particular a liquid metal cooled nuclear reactor, provided with a protection system for shutdown of the reactor in accidental conditions, comprising one shutdown or more devices characterized in that their actuation is determined by a range of accidental phenomena.

### BACKGROUND

A nuclear reactor is normally provided with at least two independent shutdown systems. The most common shutdown system consists of rods designed to insert absorbent material inside the core. In the case of a fast reactor it is also possible to control the power by moving absorbent material towards or away from the periphery of the core. It is also possible to shut down the reactor by increasing neutron leakage. The patent JP2017187361A describes a shutdown system based on the use of gas expansion modules (GEM) consisting of a hollow tubular structure closed at the top and open at the bottom, containing primary coolant in the area facing the core and with a gas cover at the top. When the circulation pumps are shut down, the pressure reduction of the primary coolant contained in the GEM allows expansion of the gas contained in the upper part with consequent lowering of the level of primary fluid contained inside the GEM, increase of neutron leakage and shutdown of the reactor.

This solution is not without drawbacks as it takes place only by shutting down the circulation pumps and is not suitable for all reactor layouts, as not all known reactor layouts obtain an appreciable pressure reduction at the core inlet when the pumps are shut down. Moreover, the known solution causes a dangerous increase in the reactivity of the reactor in case of subsequent untimely start-up of the pumps and does not protect against fundamental accidental sequences such as those that lead to an increase in the temperature of the core and of the primary coolant. It is instead important to ensure shutdown of the reactor in the very case of increase of said temperature and for some types of plant it is also necessary to protect the primary system from violent overpressures such as those generated by breakage of a tube of the steam generator.

### SUMMARY

An object of the following invention is to provide solutions that produce shutdown of the reactor for a range of accidental phenomena, including those that lead to a temperature increase of the reactor. For reactors with steam generator inside the tank of the reactor and operating at secondary side pressure higher than the primary side pressure, it is particularly important to provide the reactor with passive protection in case of pressurization accidents of the reactor. To the best of the inventor's knowledge, to date no passive protection has been published for this type of accident.

Therefore, the present invention relates to a nuclear reactor, as defined in the appended claim 1 and, for its auxiliary features and plant configurations, in the dependent claims.

In brief, the present invention relates to a nuclear reactor, in particular a fast nuclear reactor, preferably cooled with heavy liquid metal or molten salts, in which the core is surrounded by shutdown devices. The shutdown devices have a substantially vertical height and have an upper volume and a lower volume separated by a septum. The upper volume contains an operating fluid in the part thereof facing the active part of the core, in particular the same primary fluid of the reactor, with neutron reflecting function to facilitate reaching the critical mass of the reactor. The lower volume contains a neutron transparent medium (for example gas) or even a neutron absorbing medium (for example boron carbide balls immersed in the primary fluid). Replacement in the upper volume of the neutron reflecting operating fluid with a neutron transparent or absorbing medium reduces the reactivity of the reactor and causes its shutdown. This can take place both by transfer of operating fluid from the upper volume to the lower volume by at least one siphon passing through the septum, so as to drain the portion facing the core of the upper volume of operating fluid and replace it with the neutron transparent or absorbing medium previously floating above the operating fluid; and by fusion or breakage of the septum when a preset temperature or pressure threshold is exceeded, to allow neutron transparent or absorbing material to flow upward and float in the upper volume.

Transfer of the operating fluid from the upper volume to the lower volume can take place by fusion of a fusible portion of the septum or through at least one siphon for pressurization of the upper volume by active injection of gas at a higher pressure, but also passively, through an increase in the temperature of the same gas following a temperature increase of the primary fluid of the reactor, or through reduction of an inner volume of the upper volume defined inside an elastic deformable body, which collapses following a pressure increase of an outer volume of the upper volume in communication with the primary fluid.

In a particular construction configuration of the outer volume of the upper volume that surrounds the collapsible elastic body, this outer volume instead contains gas in normal operation of the reactor, but can be flooded through overflowing of primary fluid following seismic waves, leading to collapse of the inner volume (inside the elastic deformable body) by effect of buoyancy on the primary fluid and consequent shutdown of the reactor.

### BRIEF DESCRIPTION OF THE DRAWINGS

The invention is further described in the following non-limiting examples of embodiment, with reference to the figures of the accompanying drawings, wherein:

FIG. 1 is an overall schematic longitudinal sectional view of a nuclear reactor provided with a protection system in accordance with the invention;

FIG. 2 is an overall schematic longitudinal sectional and enlarged view of only the protection system according to a first embodiment of the invention;

FIG. 3 is an enlarged schematic view of a portion of the section of FIG. 2;

FIG. 4 is an overall schematic longitudinal sectional view that shows another example of the protection system of the invention;

FIGS. 4A and 4B are sectional views along the planes A-A and B-B of FIG. 4 respectively;

FIG. 5 is an overall schematic longitudinal sectional view showing another example of the protection system of the invention;

FIG. 6 is an overall schematic longitudinal sectional view showing another example of the protection system of the invention;

FIG. 7 is an overall schematic longitudinal sectional view showing a further example of the protection system of the invention.

### DESCRIPTION OF EMBODIMENTS

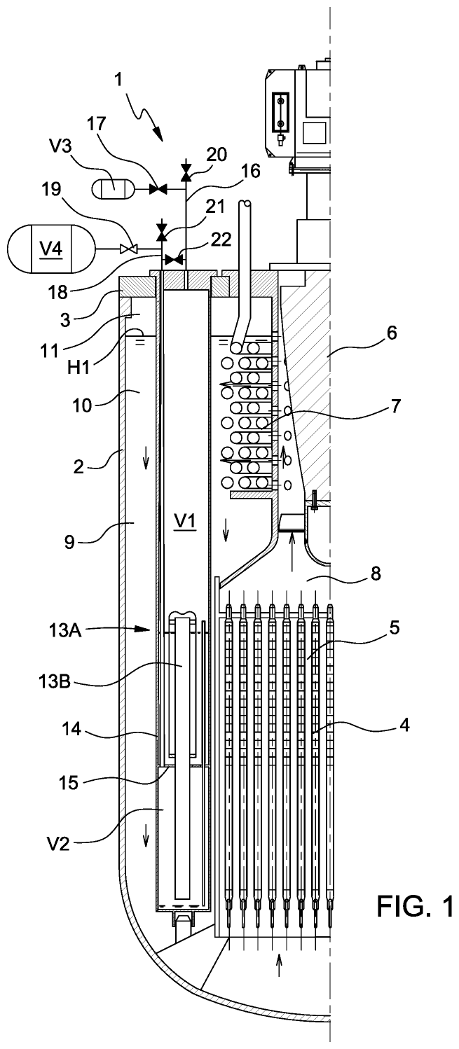

With reference to FIG. 1, representative of a nuclear reactor 1 in particular cooled with liquid metal or molten salts, the nuclear reactor 1 comprises a tank 2 substantially bowl or pool shaped and a closing structure 3. It is understood that the invention can be applied to reactors of other type and/or operating with another primary fluid.

The tank 2 contains a core 4 with an active part 5 thereof, at least one circulation pump 6, at least one heat exchanger 7, in particular a steam generator, a hot collector 8 and a cold collector 9 in which a primary fluid 10 for cooling the core 4 circulates and which fills it to the level H1, leaving a free space 11 containing a cover gas 12 at the top.

The reactor is provided with a protection system 13A for shutdown of the reactor in accidental conditions. In particular, the protection system comprises one or more shutdown devices 13B arranged laterally and radially outside with respect to the core 4; preferably, the protection system 13A comprises a plurality of shutdown devices 13B (only one of which is shown in FIG. 1 and in the subsequent figures) arranged around the core 4 and radially outside with respect to the core 4.

Each shutdown device 13B of the protection system 13A has a casing 14 arranged laterally and radially outside with respect to the core 4 and facing the core 4 and which is fixed to the closing structure 3.

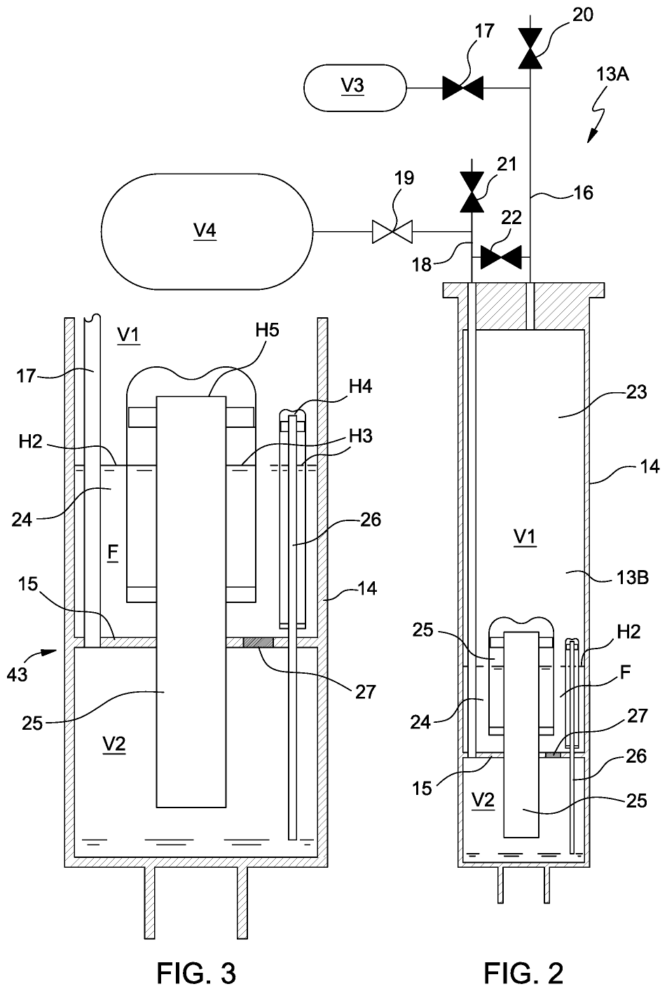

With reference to FIGS. 1, 2 and 3, the shutdown device 13B comprises a casing 14, for example (but not necessarily) substantially cylindrical, which is provided with a septum 15 that delimits inside the casing 14 an upper volume V1 and a lower volume V2. The volume V1 is also connected to the high pressure volume V3 by a duct 16 and a gas inlet valve 17, and the volume V2 is connected by a duct 18 and a valve 19 to the service volume V4. The ducts 16 and 18 are also provided with respective service valves 20, 21 and a connection valve 22 arranged between the ducts 16, 18. The volumes V3 and V4 contain gas, the volume V2 normally contains gas, the volume V1 normally contains gas in its upper part 23 and contains in its lower part 24, up to a level H2, an operating fluid F, preferably a heavy liquid metal, for example of the same type of the primary fluid 10.

The septum 15 is arranged at the lower limit of the active part 5 of the core 4, i.e., at the level of a lower end of the active part 5 of the core 4. The operating fluid F is thus positioned close to the active part 5 of the core 4, while the volume V2 is positioned below the active part 5 of the core 4. The lower part 24 of the volume V1 communicates with the volume V2 through at least one siphon 25 with a greater diameter and a siphon 26 with a smaller diameter. The operating fluid F determines a second level H3 inside the siphons. The level H4 at which the siphon 26 with a smaller diameter is primed is lower than the level H5 at which the siphon 25 with a greater diameter is primed. The septum 15 contains a collapsible portion 27, in particular which can fuse, being made of a material that fuses at a preset temperature.

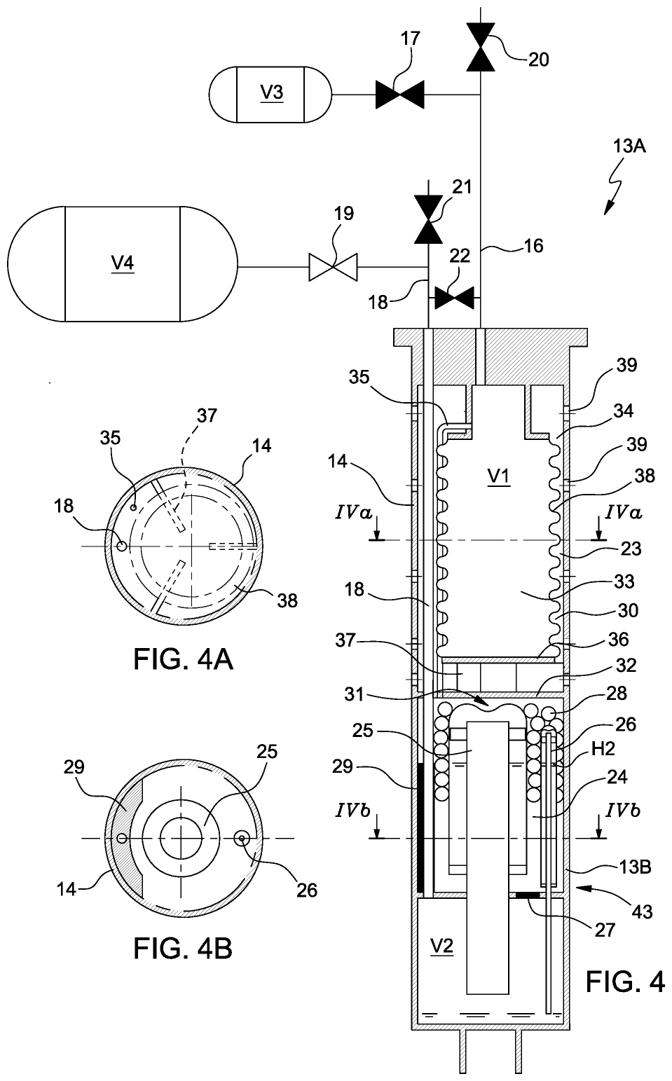

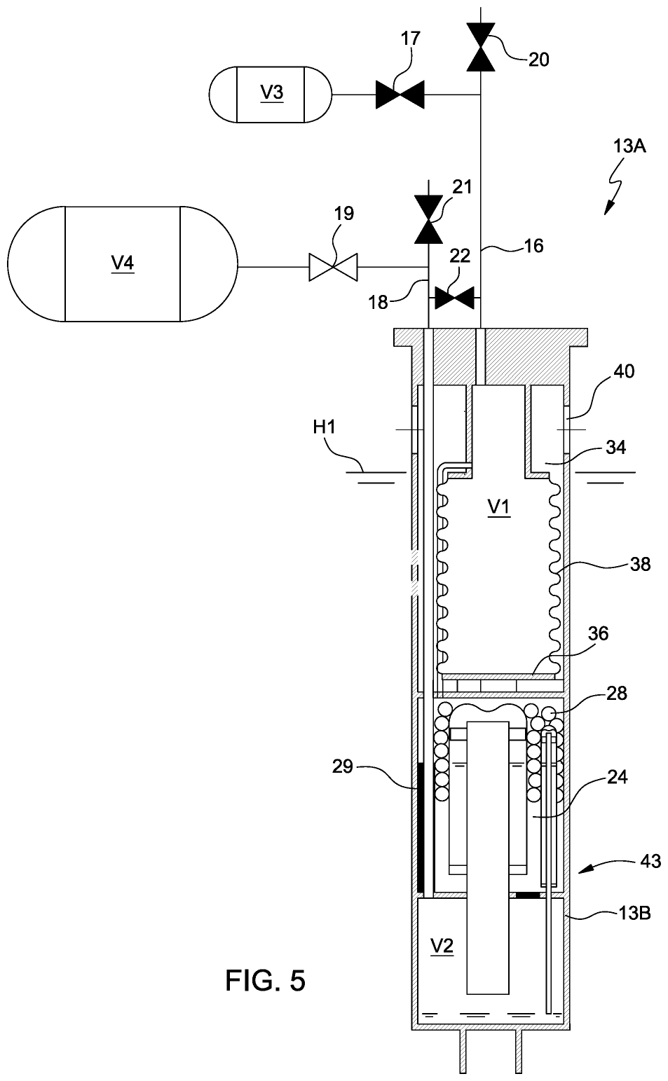

In the embodiment of FIGS. 4 and 5, a first neutron absorbing material 28 having a density lower than the operating fluid F, for example in the form of boron carbide balls, is arranged and mostly floats on the surface of the operating fluid F at the level H2. Moreover, a second neutron absorbing material 29, which can again be formed of boron carbide or of another material having similar function, is positioned inside the casing 14 at the same level of the operating fluid F in the radially outermost area from the periphery of the core 4. The upper part 23 of the volume V1 is divided into an upper portion 30 and a lower portion 31 separated by a second septum 32. The upper portion 30 is in turn divided into an inner volume 33 and an outer volume 34. The inner volume 33 is closed save for the communications with the duct 16 and, via a connection duct 35, with the lower portion 31 of the volume V1. The inner volume 33 is closed below by the bottom 36, resting on supports 37 and is defined inside an elastic deformable body 38 for most of its vertical height, designed to vary its inner volume, for example substantially bellows shaped. With reference to FIG. 4, which also applies to reactors without cover gas, the outer volume 34 is in communication along the whole of its vertical height with the primary fluid 10 of the reactor via holes 39 formed in the casing 14.

In the variant of FIG. 5 the outer volume 34 contains gas and communicates in its top part with the cover gas 12 of the reactor via wide openings 40 formed in the casing 14 and positioned above the level H1 of the primary fluid 10.

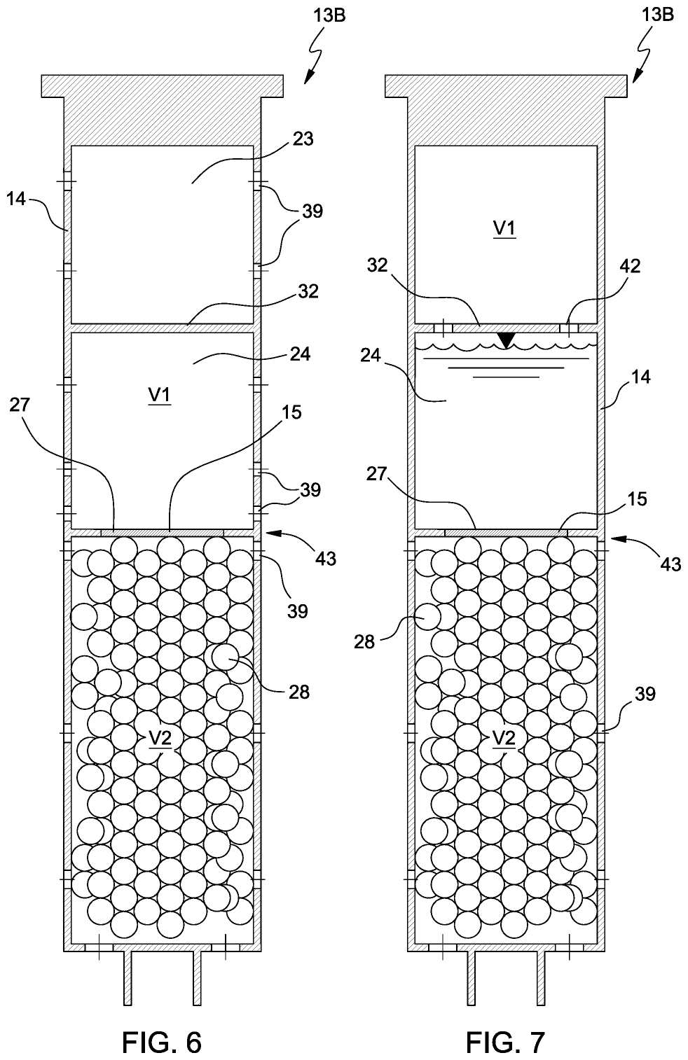

In the embodiment of FIG. 6, the volume VI is separated from the volume V2 by the septum 15, which comprises a collapsible portion 27, in particular which can fuse, being made of a material that fuses at a preset temperature. The volume V1 and the volume V2 are both in communication with the primary fluid 10 via holes 39 of the casing 14. The volume VI is divided into an upper part 23 and a lower part 24 thereof by a second septum 32. The volume V2 contains neutron absorbing material 28 preferably in the form of balls.

In the embodiment of FIG. 7 the volume VI is separated from the volume V2 by the septum 15 containing a collapsible portion 27 thereof, which can fuse at a preset temperature and break at a preset pressure.

The volume V2 communicates with the primary fluid 10 via holes 39 of the casing 14. The volume V2 contains neutron absorbing material 28 of larger size than the holes 39, preferably in the form of balls. The volume VI is closed, contains gas, optionally at a lower pressure with respect to the cover gas 12 and in its lower part 24, facing the active part 5 of the core 4, preferably contains a neutron reflecting fluid, typically the primary fluid 10. The volume V1 also contains a second septum 32, with holes 42 smaller than the size of the neutron absorbing material 28, located at a level H6 corresponding to the upper end of the active part 5 of the core 4.

With reference to FIGS. 1-5, during normal operation of the reactor, the volumes V1 and V2 are substantially at the same pressure so as to maintain the levels H2 and H3 of the operating fluid F inside and outside the siphons 25 and 26 substantially at the same height. This can be achieved, for example, via temporary opening of the valve 22. The valves 17, 20 and 21 are normally closed while the valve 19 is normally open and places the volume V2 in communication with the volume V4. The volumes V3 and V4 are outside the reactor and contain cold gas; the volume V3 is at a pressure considerably higher than the volume V1.

A feature of the invention is that a plurality of plant parameters that exceed the preset limits can each independently activate the system of the invention to cause a reduction in the reactivity of the reactor.

A first shutdown mode of the reactor is possible by the operator or by the protection systems by opening the gas inlet valve 17, which in particular can be an explosive valve, so as to place the volume V3 in communication with the volume V1, causing a rapid pressure increase of the volume V1 and consequent transfer of operating fluid F from the volume VI to the volume V2 by the siphons 25 and 26. Replacement of the operating fluid F, having neutron reflecting function, with gas in the lower part 24 of the volume V1 adjacent to the core causes the increase of neutron leakage and shutdown of the reactor. Where necessary, the introduction of negative reactivity can be amplified by the use of the first neutron absorbing material 28, which through lowering the level of operating fluid F is brought close to the core. In this case, the shutdown intervention can be very fast. The introduction of negative reactivity can also be amplified by the use of the second neutron absorbing material 29, which through lowering of the level of operating fluid F is no longer shielded by the neutron reflecting operating fluid F, thereby amplifying the neutron absorption function.

The system can be rearmed once more by opening the service valve 20, closing the valve 19, and injecting gas into the volume V2 via the service valve 21 and the duct 18, to cause the fluid F to rise from the volume V2 to the volume V1 through the siphons 25 and 26.

A second mode of intervention can take place in an entirely passive way, in case of a temperature increase of the primary fluid 10 of the cold collector 9 of the reactor which can, for example, take place as a result of the generalized loss of the power supply of the plant. In this case the temperature increase of the gas contained in the volume V1 causes a pressure increase of the same gas with lowering of the level H2 and rising of the level H3 of the operating fluid F outside and inside the siphons 25 and 26 respectively to the activation level H4 of the siphon with smaller diameter, with progressive emptying of the fluid F from the volume V1 with filling of the lower volume V2 which is hence away from the active part of the core. In this case the reactor can be shut down when the preset temperature threshold is exceeded, even without the intervention of the operator and in case of concurrent malfunction of the protection logic of the automatic safety systems of the reactor.

A third mode of intervention is determined by the temperature increase and consequent fusion of the collapsible portion 27 which, when the threshold temperature at which it fuses is exceeded, causes displacement of the operating fluid F by gravity from volume V1 to volume V2.

A fourth mode of intervention is determined by the excessive pressure increase of the primary system. The pressure increase of the primary fluid 10 of the reactor takes place, for example, in case of breakage of a tube of the heat exchanger 7 (steam generator). This pressure increase determines compression of the elastic deformable body 38, with reduction of the inner volume 33 and activation of the siphons 26 and 25 that cause shutdown of the reactor according to modes already described.

Also in the case in which the outer volume 34 (FIG. 5) only communicates with the cover gas 12, its pressure increase produces an effect analogous to that of the configuration of FIG. 4.

The intervention of the siphon 25 with greater diameter is a function of the rapidity of the pressure increase of the cover gas 12 of the reactor.

A fifth mode of intervention is determined by the earthquake in the configuration of FIG. 5. The earthquake causes waves on the level H1 of the fluid F, which if intense can cause overflowing of the primary fluid 10 inside the outer volume 34 through the wide openings 40, causing a reduction of the inner volume 33 by effect of buoyancy thereof with deformation of the body 38.

In the diagram of FIG. 6 in which the neutron absorbing material is positioned below the septum 15, it is the buoyancy of the primary fluid 10 that, when the fusion temperature of the septum 15 is exceeded, brings the neutron absorbing material 28 inside the lower part 24 in front of the active part 5 of the core 4.

In the diagram of FIG. 7 in which the neutron absorbing material is again positioned under the septum 15, it is once again the buoyancy of the primary fluid 10 that, when the fusion temperature of the portion 27 of the septum 15 is exceeded, or when the pressure loads of the same portion 27 are exceeded, brings the neutron absorbing material 28 inside the lower part 24 in front of the active part 5 of the core 4. The second septum 32 allows leakage of the primary fluid 10 to reduce the overpressure of the primary fluid 10, but forms a barrier for the neutron absorbing material 28 which must be positioned in front of the active part 5 of the core 4.

In all cases, the shutdown devices 13B have an upper volume V1 and a lower volume V2 separated by a septum 15. The upper volume V1 contains the operating fluid F in its part facing the active part 5 of the core 4, in particular the same primary fluid 10, with neutron reflecting function to facilitate reaching the critical mass of the reactor. The volume V2 instead contains a neutron transparent medium (for example a gas) or, according to the configuration of the shutdown device 13B, a neutron absorbing medium (for example boron carbide balls immersed in the primary fluid). The protection system 13A is configured so as to activate replacement of the neutron reflecting operating fluid F with the neutron transparent or absorbing medium in the upper volume V1, thereby reducing the reactivity of the reactor and causing its shutdown. This can take place both through transfer of operating fluid F from the volume V1 to the volume V2 through one or more siphons 25, 26 passing through the septum 15 to drain operating fluid F from the portion of the volume V1 facing the core and replace it with the neutron transparent or absorbing medium previously floating above the operating fluid F, and through fusion or breakage of the septum 15 to allow the neutron transparent or absorbing material in the lower part 24 of the volume V1 to flow upward and float.

Transfer of the operating fluid F from the volume V1 to the volume V2 can take place by fusion of the portion 27 of the septum 15 or through the siphons 25, 26 by pressurization of the volume V1 through active injection of gas at a higher pressure, but also passively through the temperature increase of the same gas following a temperature increase of the primary fluid of the reactor or through reduction of the volume V1 by collapsing an upper part thereof following the pressure increase of the outer volume 34 in communication with the primary system of the reactor.

The particular construction configuration (FIG. 5) of the outer volume 34 normally containing gas, but floodable by overflowing of primary fluid 10 following seismic waves, can cause a collapse of the inner volume 33 by effect of buoyancy on the primary fluid 10 and consequent shutdown of the reactor.

Therefore, in accordance with the invention, the septum 15 inside each casing 14 is associated with at least one exclusion device 43, defined in this case by the siphons 25, 26 and/or by the collapsible portion 27, configured so as to exclude the separation function of the septum 15 to replace, at least in part, the neutron reflecting operating fluid F with the neutron transparent or neutron absorbing medium inside the casing 14 in front of the active part 5 of the core 4.

The advantages of the present invention are evident from the description above:
shutdown of the reactor through the device described can take place in an entirely passive manner and, according to its embodiments, also through a command executed by the operator or by the protection logic to deal with different accidental sequences;
one or more plant parameters that exceed the preset limits can, according to its embodiments, activate the system;
the system can be rearmed according to its embodiments, but only with intervention of the operator and not by returning within the design limits of the parameter that actuated it;
the system is positioned on the periphery of the core and therefore does not influence its mechanical design;
actuation by the operator, by the protection logic or by the temperature increase of the reactor does not require the operation of mechanical members inside the tank of the reactor;
actuation due to pressure increase of the reactor or to a seismic movement thereof is simply the result of an elastic or plastic deformation or of a preset breakage of a component;
the reduction of the inner volume 33 of FIGS. 4 and 5 following a pressure increase of the primary fluid contributes to reduce the pressure transient, a particularly useful effect in case of a plant layout solution without cover gas 12 being adopted;
filling of the volume V1 with primary fluid 10 according to FIG. 7 following a pressure increase of the primary fluid contributes to reduce the pressure transient, a particularly useful effect in case of a plant layout solution without cover gas 12 being adopted.

It is clear that the various configurations described can be combined together, just as they can be used separately from one another, also with functions other than shutdown of the reactor. In particular, it must be noted that the solutions in which the system is activated following a pressure increase of the primary fluid can also be used autonomously with respect to the function of shutting down the reactor, with the function of reducing the pressure transient of the primary fluid (especially when a cover gas is not provided above the primary fluid).

Finally, it is understood that further modifications and variants may be made to the reactor described and illustrated herein without departing from the scope of the appended claims.

1-16. (canceled)

17. A nuclear reactor, comprising:
a protection system for shutdown of the nuclear reactor in accidental conditions, the protection system including:
one or more shutdown devices arranged laterally and radially outside with respect to a core of the nuclear reactor;
wherein the one or more shutdown device has a casing positioned laterally with respect to the core and at least partly facing the core, the casing including:
a septum that delimits inside the casing an upper volume and a lower volume separated by the septum, the upper volume containing a neutron reflecting operating fluid in front of an active part of the core and the lower volume containing a neutron transparent or neutron absorbing medium;
wherein the one or more shutdown devices include at least one exclusion device configured to exclude the separation function of the septum to replace, at least in part, the neutron reflecting operating fluid with the neutron transparent or neutron absorbing medium inside the casing in front of the active part of the core.

18. The nuclear reactor according to claim 17, wherein the upper volume includes a lower part facing the active part of the core and that is hydraulically connected to the lower volume by at least one siphon passing through the septum, the at least one siphon having a greater diameter and a siphon with a smaller diameter, and such that a pressure increase of the operating fluid in the upper volume causes a rise in level of the operating fluid inside the at least one siphon or siphons up to one or more overflow levels to activate the respective siphons and bring the operating fluid from the lower part, facing the core, of the upper volume to the lower volume away from the core so as to increase neutron leakage and to cause reactor shutdown.

19. The nuclear reactor according to claim 18, wherein the lower volume is hydraulically connected to a service volume outside the core so as to limit the pressure increase in the lower volume during filling with the operating fluid.

20. The nuclear reactor according to claim 18, further comprising a first neutron absorbing material having a density lower than the operating fluid, the first neutron absorbing material including boron carbide balls, floats in the upper volume above the operating fluid so as to bring said first neutron absorbing material close to the core when the level of the operating fluid in the upper volume lowers.

21. The neutron reactor according to claim 18, further comprising a second neutron absorbing material is positioned inside the upper volume at the same level of the operating fluid and facing the operating fluid and in a radially outermost area with respect to the core, so that a lowering of the level of the operating fluid in the upper volume amplifies the function of said second neutron absorbing material as a result of the lack of neutron reflecting fluid interposed with respect to the core.

22. The nuclear reactor according to claim 18, wherein the upper volume is hydraulically connected to a high pressure volume, containing a gas at a pressure higher than the upper volume, by a duct provided with a gas inlet valve; and wherein the opening of the gas inlet valve connects the high pressure volume with the upper volume so as to cause pressurization of the upper volume and actuation of the siphons causing transfer of operating fluid from the upper volume to the lower volume through the septum with consequent shutdown of the reactor.

23. The nuclear reactor according to claim 18, wherein the protection system is configured so that a temperature increase of the primary fluid of the nuclear reactor and the consequent pressurization of the gas contained inside the volume, with respect to the lower volume having a pressurization limited by the service volume, activates one or more siphons with consequent displacement of operating fluid from the upper volume to the lower volume through the septum with consequent shutdown of the nuclear reactor.

24. The nuclear reactor according to claim 23, wherein the lower volume communicates with a duct provided with a service valve by which gas can be fed into the lower volume to rearm the protection system after intervention by causing the operating fluid to rise from the lower volume to the upper volume through the siphon or siphons.

25. The nuclear reactor according to claim 17, wherein the septum includes at least one collapsible portion that fuses at a preset temperature; and wherein fusion of said collapsible portion causes transfer of the operating fluid from the upper volume to the lower volume with consequent shutdown of the reactor.

26. The nuclear reactor according to claim 22, wherein in an upper part of the upper volume there is an elastic deformable body, which divides the upper volume into an inner volume inside said elastic deformable body and an outer volume outside said elastic deformable body; the inner volume being closed and delimited below by a bottom and communicating, via a connection duct, with a lower portion of the upper volume; said elastic deformable body being contained inside the outer volume which is in communication with the primary fluid via holes formed in the casing along the whole vertical height of the outer volume; and wherein a pressure increase in the outer volume, following a pressure increase of the primary fluid, causes the elastic deformable body to collapse with consequent reduction of the inner volume and activation of the at least one siphon or siphons.

27. The nuclear reactor according to claim 22, wherein in the upper part of the upper volume there is an elastic deformable body, which divides the upper volume into an inner volume inside said elastic deformable body and an outer volume outside said elastic deformable bodybody; the inner volume being closed and delimited below by a bottom and communicating, via a connection duct, with a lower portion of the upper volume; said elastic deformable body being contained inside the outer volume which contains gas, in turn communicating with the cover gas of the reactor via openings positioned in the upper part of the casing above the level of the primary fluid; and wherein the openings are configured so that accidental wave motion of the primary fluid, due for example to an earthquake, causes overflowing of primary fluid inside the outer volume and consequent collapse of the body by effect of buoyancy of the primary fluid, with consequent actuation of the siphon or siphons.

28. The nuclear reactor according to claim 26, wherein the reduction of the inner volume following a pressure increase of the primary fluid and collapse of the body contributes to reduce the pressure transient of the whole primary system of the nuclear reactor.

29. The nuclear reactor according to claim 22, further comprising a connection valve between the two ducts communicating with the upper volume and the lower volume respectively; wherein by opening the connection valve, the levels of the operating fluid are restored outside and inside the at least one siphon or siphons respectively.

30. The nuclear reactor according to claim 17, wherein the neutron reflecting operating fluid is the same primary fluid of the nuclear reactor, with which the lower part of the upper volume facing the core communicates via holes formed in the casing.

31. The nuclear reactor according to claim 30, wherein the lower volume contains primary fluid, with which the lower volume communicates via further holes formed in the casing, and also a first neutron absorbing material which in case of a temperature increase exceeding a preset threshold and consequent fusion of the collapsible portion, which fuses above said threshold, of the septum, moves by floating inside the lower part to shut down the reactor.

32. The nuclear reactor according to claim 17, wherein the upper volume is a closed volume and the lower volume contains primary fluid with which the lower volume communicates via holes formed in the casing and also a first neutron absorbing material; the septum comprising at least a collapsible portion which breaks above a preset pressure threshold, so that in case of a pressure increase above said pressure threshold and breakage of the collapsible portion of the septum, there is a transfer of primary fluid inside the lower part to reduce the pressure increase of the primary system of the nuclear reactor.

33. The nuclear reactor of claim 17, wherein the neutron reflecting operating fluid of the upper volume includes a liquid metal.

34. The nuclear reactor of claim 17, wherein the casing of the one or more shutdown devices is substantially cylindrical.
